(19) United States
(12) Patent Application Publication
(10) Pub. No.: US 2018/0245011 A1
(43) Pub. Date: Aug. 30, 2018

(54) A BASE OIL ADDITIVE

(71) Applicant: AGENCY FOR SCIENCE, TECHNOLOGY AND RESEARCH, Singapore (SG)

(72) Inventors: Qun YE, Singapore (SG); Jianwei XU, Singapore (SG); Hong YAN, Singapore (SG); Hui ZHOU, Singapore (SG)

(21) Appl. No.: 15/753,544

(22) PCT Filed: Aug. 19, 2016
(86) PCT No.: PCT/SG2016/050404

§ 371 Date: Feb. 19, 2018

(30) Foreign Application Priority Data
Aug. 19, 2015 (SG) 10201506539V

(51) Int. Cl. C10M 129/70; C10M 129/74; C10M 169/04; C11C 3/00

(52) U.S. Cl. CPC C10M 129/70; C10M 129/74; C10M 169/04; C10N 2230/02; C10M 2207/281; C10M 2207/283; C11C 3/003

(57) ABSTRACT

There is provided a base oil additive comprising an ester of a palmitic acid, a method of forming the base oil additive, a lubricating oil composition comprising the base oil additive and a method of modifying a property of a base oil.

### TECHNICAL FIELD

The present invention generally relates to a base oil additive. The present invention also relates to a method of producing a base oil additive, a lubricating oil composition, and a method for modifying a property of a base oil.

### BACKGROUND ART

Base oils may typically contain a number of oil additives to improve on the properties of the base oil. Based on the application(s) intended for the base oil, an appropriate additive with the desired property can be added to the base oil. Often, more than one additive will be added to the base oil in order to result in an oil composition with a number of the desired properties. Additives that can be added to base oils would include those used to alter or modify the rheological property of the base oil (such as the viscosity or lubricity of the base oil), to control the level of contaminant in the base oil, to control the breakdown of the chemical components in the base oil and/or for seal conditioning.

Current commonly used rheology modifiers in base oils mainly include acrylic polymers, polyethylene, or polyethylene oxide, etc. The starting materials of these polymers are mainly from petroleum based chemicals and may add to environmental pollution and contamination. Other additives that are commonly used are emulsifiers in grease lubricants such as soaps that include calcium stearate, sodium stearate or lithium stearate.

There is a need to provide an additive for a base oil that is derived from biomass products. There is a need to provide an additive that is both a rheological modifier and a grease former.

### SUMMARY OF INVENTION

According to a first aspect, there is provided a base oil additive comprising an ester of a palmitic acid.

Advantageously, the palmitic acid ester can serve as a high performance and environmentally friendly base oil additive.

According to a second aspect, there is provided a method for forming a base oil additive, comprising the step of esterifying a palmitic acid in the presence of an acid catalyst and an alcohol to form an ester of said palmitic acid.

According to a third aspect, there is provided a lubricating oil composition comprising a base oil and a base oil additive comprising an ester of a palmitic acid.

According to a fourth aspect, there is provided method for modifying a property of a base oil comprising the step of adding an ester of a palmitic acid as an additive to said base oil.

### Definitions

The following words and terms used herein shall have the meaning indicated:

The term “carboxylic acid” is to be interpreted broadly to include any organic compound that contains a carboxyl group (—C(O)OH). The carboxylic acid may be a monocarboxylic acid, a fatty acid or a polycarboxylic acid. In general, the carboxylic acid may be depicted by the formula R₁—(C(O)OH)ₙ where R₁ refers to an alkyl, an alkenyl or an alkynyl and n refers to a number that is at least 1. Where the carboxylic acid is palmitic acid, the formula of palmitic acid is C₁₅H₃₁COOH.

The term “alcohol” is to be interpreted broadly to refer to any organic compound which has a hydroxyl function group (—OH) bonded to a carbon atom. The alcohol may be an aliphatic alcohol which may be saturated or unsaturated. The number of hydroxyl functional groups on the alcohol may be at least one (forming a monohydric alcohol) or more than one (forming a polyhydric alcohol). In general, the alcohol may be depicted by the formula R₂—(OH)ₘ, where R₂ refers to an alkyl, an alkenyl or an alkynyl and m refers to a number that is at least 1.

The term “ester” is to be interpreted broadly to refer to any organic compound which has a —C(O)O group therein. An ester is derived from the reaction between a carboxylic acid and an alcohol.

The term “alkyl” is to be interpreted broadly to include straight chain or branched chain saturated aliphatic groups having from 1 to 20 carbon atoms, eg, 1, 2, 3, 4, 5, 6, 7, 8, 9, 10, 11, 12, 13, 14, 15, 16, 17, 18, 19 or 20 carbon atoms. For example, the term alkyl includes, but is not limited to, methyl, ethyl, 1-propyl, isopropyl, 1-butyl, 2-butyl, isobutyl, tert-butyl, amyl, 1,2-dimethylpropyl, 1,1-dimethylpropyl, pentyl, isopentyl, hexyl, 4-methylpentyl, 1-methylpentyl, 2-methylpentyl, 3-methylpentyl, 2,2-dimethylbutyl, 3,3-dimethylbutyl, 1,2-dimethylbutyl, 1,3-dimethylbutyl, 1,2,2-trimethylpropyl, 1,1,2-trimethylpropyl, 2-ethylpentyl, 3-ethylpentyl, heptyl, 1-methylhexyl, 2,2-dimethylpentyl, 3,3-dimethylpentyl, 4,4-dimethylpentyl, 1,2-dimethylpentyl, 1,3-dimethylpentyl, 1,4-dimethylpentyl, 1,2,3-trimethylbutyl, 1,1,2-trimethylbutyl, 1,1,3-trimethylbutyl, 5-methylheptyl, 1-methylheptyl, octyl, nonyl, decyl, undecyl, dodecyl, tridecyl, tetradecyl, pentadecyl, hexadecyl, heptadecyl, octadecyl, nonadecyl, eicosly and the like.

The term “alkenyl” is to be interpreted broadly to include straight or branched chain unsaturated aliphatic hydrocarbon groups having from 2 to 20 carbon atoms, eg, 2, 3, 4, 5, 6, 7, 8, 9, 10, 11, 12, 13, 14, 15, 16, 17, 18, 19 or 20 carbon atoms and having at least one double bond, of either E, Z, cis or trans stereochemistry where applicable, anywhere in the alkyl chain. Examples of alkenyl groups include but are not limited to ethenyl, vinyl, allyl, 1-methylvinyl, 1-propenyl, 2-propenyl, 2-methyl-1-propenyl, 2-methyl-1-propenyl, 1-butenyl, 2-butenyl, 3-butentyl, 1,3-butadienyl, 1-pentenyl, 2-pententyl, 3-pentenyl, 4-pentenyl, 1,3-pentadienyl, 2,4-pentadienyl, 1,4-pentadienyl, 3-methyl-2-butenyl, 1-hexenyl, 2-hexenyl, 3-hexenyl, 1,3-hexadienyl, 1,4-hexadienyl, 2-methylpentenyl, 1-heptenyl, 2-heptentyl, 3-heptenyl, 1-octenyl, 1-nonenyl, 1-decenyl, 1-undecenyl, 1-dodecenyl, 1-tridecenyl, 1-tetradecenyl, 1-pentadecenyl, 1-hexadecenyl, 1-heptadecenyl, 1-octadecenyl, 1-nonadecenyl, 1-eicosenly and the like.

The term “alkynyl” is to be interpreted broadly to include straight or branched chain unsaturated aliphatic hydrocarbon groups having from 2 to 20 carbon atoms, eg, 2, 3, 4, 5, 6, 7, 8, 9, 10, 11, 12, 13, 14, 15, 16, 17, 18, 19 or 20 carbon atoms and having at least one triple bond anywhere in the carbon chain. Examples of alkynyl groups include but are not limited to ethynyl, 1-propynyl, 1-butynyl, 2-butynyl, 1-methyl-2-butynyl, 3-methyl-1-butynyl, 1-pentynyl, 1-hexynyl, methylpentynyl, 1-heptynyl, 2-heptynyl, 1-octynyl, 2-octynyl, 1-nonyl, 1-decynyl, 1-undecynyl, 1-dodecynyl, 1-tridecynyl, 1-tetradecynyl, 1-pentadecynyl, 1-hexadecynyl, 1-heptadecynyl, 1-octadecynyl, 1-nonadecynyl, 1-eicosynyl and the like.

The term “cycloalkyl” is to be interpreted broadly to include cyclic saturated aliphatic groups and saturated, monocyclic, bicyclic, polycyclic or fused polycyclic hydrocarbon radicals having from 3 to 20 carbon atoms, eg, 3, 4, 5, 6, 7, 8, 9, 10, 11, 12, 13, 14, 15, 16, 17, 18, 19 or 20 carbon atoms. Examples of cycloalkyl groups include but are not limited to cyclopropyl, 2-methylcyclopropyl, cyclobutyl, cyclopentyl, 2-methylcyclopentyl, 3-methylcyclopentyl, cyclohexyl, cycloheptyl, cyclooctyl, cyclononyl, cyclodecyl, cycloundecyl, cyclododecyl, cyclotridecyl, cyclotetradecyl, cyclopentadecyl, cyclohexadecyl, cycloheptadecyl, cyclooctadecyl, cyclononadecyl, cycloeico sly and the like.

The word “substantially” does not exclude “completely” e.g. a composition which is “substantially free” from Y may be completely free from Y. Where necessary, the word “substantially” may be omitted from the definition of the invention.

Unless specified otherwise, the terms “comprising” and “comprise”, and grammatical variants thereof, are intended to represent “open” or “inclusive” language such that they include recited elements but also permit inclusion of additional, unrecited elements.

As used herein, the term “about”, in the context of concentrations of components of the formulations, typically means +/−5% of the stated value, more typically +/−4% of the stated value, more typically +/−3% of the stated value, more typically, +/−2% of the stated value, even more typically +/−1% of the stated value, and even more typically +/−0.5% of the stated value.

Throughout this disclosure, certain embodiments may be disclosed in a range format. It should be understood that the description in range format is merely for convenience and brevity and should not be construed as an inflexible limitation on the scope of the disclosed ranges. Accordingly, the description of a range should be considered to have specifically disclosed all the possible sub-ranges as well as individual numerical values within that range. For example, description of a range such as from 1 to 6 should be considered to have specifically disclosed sub-ranges such as from 1 to 3, from 1 to 4, from 1 to 5, from 2 to 4, from 2 to 6, from 3 to 6 etc., as well as individual numbers within that range, for example, 1, 2, 3, 4, 5, and 6. This applies regardless of the breadth of the range.

Certain embodiments may also be described broadly and generically herein. Each of the narrower species and subgeneric groupings falling within the generic disclosure also form part of the disclosure. This includes the generic description of the embodiments with a proviso or negative limitation removing any subject matter from the genus, regardless of whether or not the excised material is specifically recited herein.

### DETAILED DISCLOSURE OF EMBODIMENTS

Exemplary, non-limiting embodiments of a base oil additive will now be disclosed.

The base oil additive comprises an ester of a palmitic acid. As palmitic acid has a formula of C₁₅H₃₁COOH, the resultant ester is of the formula R₂—(OOCC₁₅H₃₁)ₘ, wherein R₂ is an alkyl, an alkenyl or an alkynyl; and m is at least 1.

The ester is derived from the palmitic acid and an alcohol and can thereby be regarded as the reaction product of the esterification of the palmitic acid with the alcohol. The alcohol may be of the formula R₂—(OH)ₘ, wherein R₂ and m have the meanings as above, that is, where R₂ is an alkyl, an alkenyl or an alkynyl; and m is at least 1. Advantageously, palmitic acid is used for making the ester because palmitic acid does not have any unsaturated bonds in the alkyl chain, making it suitable for preparation of base oil additives with high stability.

Where m is 1, the alcohol may be selected from the group consisting of methanol (R₂ being —CH₃), ethanol (R₂ being —CH₂CH₃), propanol (R₂ being —CH₂CH₂CH₃), isopropyl alcohol (R₂ being —C(CH₃)₂H), butyl alcohol (R₂ being —CH₂CH₂CH₂CH₃), pentanol (R₂ being —CH₂CH₂CH₂CH₂CH₃), hexanol (R₂ being —CH₂CH₂CH₂CH₂CH₂CH₃), heptanol (R₂ being —CH₂CH₂CH₂CH₂CH₂CH₂CH₃), octanol (R₂ being —C₈H₁₇), nonanol (R₂ being —C₉H₁₉), decanol, nonadecanol, dodecanol and hexadecanol.

Where m is 2, the alcohol may be selected from the group consisting of ethylene glycol, propane-1,2-diol, propane-1,3-diol, butanediol, cyclohexanediol, cyclohexanedimethanol, dianhydrohexitol, diethylene glycol, dihydroxyacetone, dipropylene glycol, ethambutol, ethylhexylglycetin, etohexadiol, 1,6-hexanediol, neopentyl glycol, octane-1,8-diol, 1,5-pentanediol, pinacol, propylene glycol, tartaric acid and triethylene glycol.

Where m is 3, 4, 5 or 6, the alcohol may be selected from the group consisting of trimethylolpropane, trimethylolethane, 1,2,4-butanetriol, glycerol, miglitol, natural oil polyols, pentaerythritol, triethanolamine, sugar alcohols (such as maltitol, sorbital, xylitol, erythritol, isomalt, volemitol, threitol, arabitol, ribitol, mannitol, galactitol, iditol, fucitol, inositol, lactitol, isomalt), phloroglucinol, dipentaerythritol, 1,1,1-tris(hydroxymethypethane, 2-hydromethyl-1,3-propanediol, 2,2-bis(hydroxymethyl)propane-1,3-diol, fragmented cellulose, fragmented chitosan, and fragmented lignin.

Where the alcohol is 2,2-bis(hydroxymethyl)propane-1,3-diol having the structure

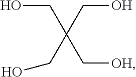

the resultant ester is

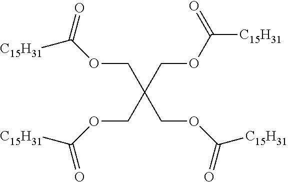

(2,2-Bis((palmitoyloxy)methyl)propane-1,3-diyl dipalmitate). Scheme 1 below is used to depict the formation of the ester above from palmitic acid and 2,2-bis(hydroxymethyl)propane-1,3-diol in the presence of toluene and methanesulfonic acid (MSA).

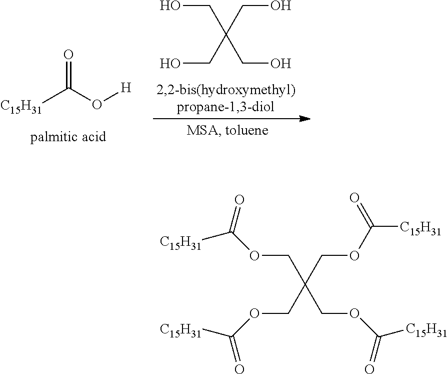

By selecting the alcohol with different number of hydroxyl groups and different chain lengths, the final physical properties of the obtained ester compounds can be easily tailored.

The selection of alcohol can also determine the structure of the resultant palmitic acid ester, whether the palmitic acid ester is straight chained or branched. As straight chained palmitic acid esters tend to have higher melting points than branched palmitic acid esters, hence, the branched palmitic acid esters can generally behave as a better thickener or grease former in base oil due to their three-dimensional geometry and stronger interaction with the base oil. Hence, the palmitic acid ester may be a straight-chained ester. The palmitic acid ester may be a branched ester.

Exemplary, non-limiting embodiments of a method for forming a base oil additive will now be disclosed.

The method for forming the base oil additive comprises the step of esterifying a palmitic acid in the presence of an acid catalyst and an alcohol to form an ester of said palmitic acid.

In the method, the palmitic acid can be reacted with the alcohol using an acid catalyst to form the ester of the palmitic acid. The alcohol used is as defined above and exemplified generally below.

Scheme 2 below shows a number of possible alcohols with varying number of hydroxyl groups (which corresponds to the m value) which ranges from 1 to 6. Hence, depending on the number of hydroxyl group, the number of ester groups would follow accordingly.

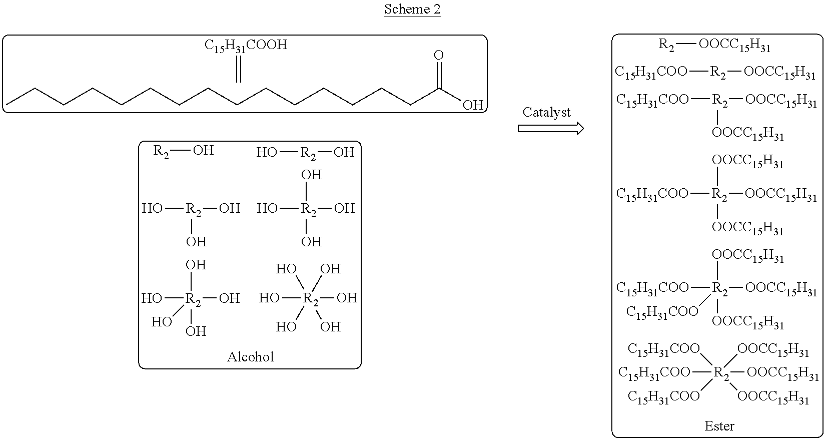

The acid catalyst may be a mineral acid catalyst or an organic acid catalyst. Where the acid catalyst is a mineral acid catalyst, the mineral acid catalyst may be selected from the group consisting of hydrochloric acid, nitric acid, hydrobromic acid, perchloric acid, sulphuric acid, phosphoric acid, polyphosphoric acid, methanesulfonic acid. Where the acid catalyst is an organic acid catalyst, the organic acid catalyst may be p-toluenesulfonic acid.

The method may comprise the step of selecting the concentration of the acid catalyst for the esterification reaction from the range of about 0.1 wt % to about 10.0 wt %, about 0.1 wt % to about 1.0 wt %, about 0.1 wt % to about 2.0 wt %, about 0.1 wt % to about 3.0 wt %, about 0.1 wt % to about 4.0 wt %, about 0.1 wt % to about 5.0 wt %, about 0.1 wt % to about 6.0 wt %, about 0.1 wt % to about 7.0 wt %, about 0.1 wt % to about 8.0 wt %, about 0.1 wt % to about 9.0 wt %, about 1 wt % to about 10.0 wt %, about 2 wt % to about 10.0 wt %, about 3 wt % to about 10.0 wt %, about 4 wt % to about 10.0 wt %, about 5 wt % to about 10.0 wt %, about 6 wt % to about 10.0 wt %, about 7 wt % to about 10.0 wt %, about 8 wt % to about 10.0 wt %, or about 9 wt % to about 10.0 wt %.

Exemplary, non-limiting embodiments of a lubricating oil composition will now be disclosed.

The lubricating oil composition comprises a base oil and a base oil additive comprising an ester of a palmitic acid.

The ester of the palmitic acid is as described above.

Suitable base oils that can be used here include natural and synthetic base oils. The natural base oils may include mineral oils (light, heavy, paraffinic, naphthenic, and aromatic) and the synthetic base oils may include polyalphaolefins, synthetic esters, polyalkylene glycols, phosphate esters, alkylated naphthalenes, silicon oils, silicate esters and ionic fluids.

The lubricating oil composition may form a grease lubricant depending on the amount of palmitic acid ester added to the base oil. The amount of palmitic acid ester added to the base oil may vary from about 0.1 wt % to about 50.0 wt (based on the weight of the base oil) for different base oil and ester compounds in order to achieve greasy nature of the blend. The amount of palmitic acid ester may be selected from about 0.1 wt % to about 50.0 wt %, about 0.1 wt % to about 5.0 wt %, about 0.1 wt % to about 10.0 wt %, about 0.1 wt % to about 15.0 wt %, about 0.1 wt % to about 20.0 wt %, about 0.1 wt % to about 25.0 wt %, about 0.1 wt % to about 30.0 wt %, about 0.1 wt % to about 35.0 wt %, about 0.1 wt % to about 40.0 wt %, about 0.1 wt % to about 45.0 wt %, about 5.0 wt % to about 50.0 wt %, about 10.0 wt % to about 50.0 wt %, about 15.0 wt % to about 50.0 wt %, about 20.0 wt % to about 50.0 wt %, about 25.0 wt % to about 50.0 wt %, about 30.0 wt % to about 50.0 wt %, about 35.0 wt % to about 50.0 wt %, about 40.0 wt % to about 50.0 wt %, about 45.0 wt % to about 50.0 wt %, or about 0.1 wt % to about 1.5 wt %, based on the weight of the base oil.

The weight percentage of the palmitic acid ester added to the base oil may influence the final properties of the lubricating oil composition, such as the viscosity, thermal properties, transparency, etc.

The type of palmitic acid ester may be a mixture of one or more different types of palmitic acid esters.

Advantageously, the palmitic acid ester may be used as a viscosity modifier. Advantageously, the palmitic acid ester may be used as a grease former. Hence, the palmitic acid ester may be able to confer two properties to the base oil, being a viscosity modifier and a grease former.

Palmitic acid (which is obtained from palm oil), is fully saturated and therefore the ester prepared from palmitic acid should possess high stability towards oxidation. Further, palm oil contains about 43.5% of palmitic acid inside, which provides a large feedstock for palmitic acid based lubricants. The isolation of palmitic acids can also be conveniently achieved during the manufacturing process of palm oil derived biodiesels. The palmitic acid based ester can serve as a bio-based rheology modifier. All these attributes of palmitic acids render high competitive attractiveness of palmitic acids based lubricant additives.

The palmitic acid based ester can also function as a grease formation agent. The ester compounds can serve as efficient grease formation agent to easily convert the oil-type lubricant into grease and gel type lubricant. As the palmitic acid based esters are non-ionic and water resistant, the implementation of such additives would widen the potential use of such lubricant in watery environment, such as underwater grease and marine grease. This is advantageous compared to conventional additives that are water soluble and have limited water proofing properties. Hence, the palmitic acid ester may be used as a base oil additive for lubricating compositions that when used, are in contact with water.

Exemplary, non-limiting embodiments of a method for modifying a property of a lubricating oil composition will now be disclosed.

The method for modifying a property of a base oil comprising the step of adding an ester of a palmitic acid as an additive to said base oil.

The additive may be added to the base oil at a concentration of about 0.1 wt % to about 50.0 wt %, about 0.1 wt % to about 5.0 wt %, about 0.1 wt % to about 10.0 wt %, about 0.1 wt % to about 15.0 wt %, about 0.1 wt % to about 20.0 wt %, about 0.1 wt % to about 25.0 wt %, about 0.1 wt % to about 30.0 wt %, about 0.1 wt % to about 35.0 wt %, about 0.1 wt % to about 40.0 wt %, about 0.1 wt % to about 45.0 wt %, about 5.0 wt % to about 50.0 wt %, about 10.0 wt % to about 50.0 wt %, about 15.0 wt % to about 50.0 wt %, about 20.0 wt % to about 50.0 wt %, about 25.0 wt % to about 50.0 wt %, about 30.0 wt % to about 50.0 wt %, about 35.0 wt % to about 50.0 wt %, about 40.0 wt % to about 50.0 wt %, about 45.0 wt % to about 50.0 wt %, or about 0.1 wt % to about 1.5 wt %, based on the weight of the base oil.

The palmitic acid ester may be blended with the base oil and if needed, subject to a heating step to a temperature that is sufficient to induce mixing of the palmitic acid ester with the base oil, for example at a temperature of up to about 100° C. The blend may be stirred while heating. When the blend turns homogeneous and/or transparent, the blend may then be subjected to a cooling step before use.

The property of the base oil that may be altered after addition of the additive may be the viscosity of the base oil or the formation of a grease from the base oil. Hence, the additive may function as a viscosity modifier and/or a grease formation agent.

Depending on the amount of base oil additive added, the viscosity may be increased by at least 10%, at least 20%, at least 50%, at least 100%, at least 150%, at least 200%, at least 250%, at least 300% or at least 350% as compared to the viscosity of a base oil without any additive. The increase in the viscosity may be equated by (viscosity of base oil with additive minus viscosity of base oil without additive) divided by viscosity of base oil without additive which is then multiplied by 100 to obtain the percentage increase.

### BRIEF DESCRIPTION OF DRAWINGS

The accompanying drawings illustrate a disclosed embodiment and serves to explain the principles of the disclosed embodiment. It is to be understood, however, that the drawings are designed for purposes of illustration only, and not as a definition of the limits of the invention.

FIG. 1 is a graph showing the viscosity change of polypropylene glycol after addition of different ratios of palmitic acid based thickeners.

FIG. 2 is a photograph showing a number of bottled samples based on base oil (polyethylene glycol) having different amounts of additives added therein at different temperatures. FIG. 2(a) from left to right shows base oil (PEG) with 0 wt %, 5 wt %, 10 wt % and 20 wt % of base oil additives on microscopic plate (at a temperature of around 20° C.). FIG. 2(b) from left to right shows base oil (PEG) with 0 wt %, 5 wt %, 10 wt % and 20 wt % of base oil additives at room temperature.

FIG. 3 is a graph showing the thermal gravity analysis of polypropylene glycol blended with different ratios of the palmitic acid based additives.

FIG. 4 is a graph showing the differential scanning calorimetry data of polypropylene glycol blended with different ratios of palmitic acid based thickeners.

FIG. 5 is a series of scanning electron microscopy images showing polypropylene glycol blended with different ratios of palmitic acid based thickeners, where (a) the top row is obtained at ×10000 magnification and (b) the bottom row is obtained at ×35000 magnification.

FIG. 6 is a series of photographs showing the thermo-reversibility test of the formed grease lubricants where (a) is the first cycle, (b) is at the tenth cycle, (c) is at the 20^{th} cycle and (d) is at the 30^{th} cycle. The four bottled samples at the left of each figure shows the state of the grease lubricants when in the “cool” state and the four bottled samples at the right of each figure shows the state of the grease lubricants when in the “heat” state (at 80° C.).

### EXAMPLES

Non-limiting examples of the invention and a comparative example will be further described in greater detail by reference to specific Examples, which should not be construed as in any way limiting the scope of the invention.

### Example 1

A palmitic acid ester was produced in this example from palmitic acid, 2,2-bis(hydroxymethyl)propane-1,3-diol in the presence of toluene and methanesulfonic acid (MSA). The reaction scheme is that depicted in Scheme 1 above and reproduced below.

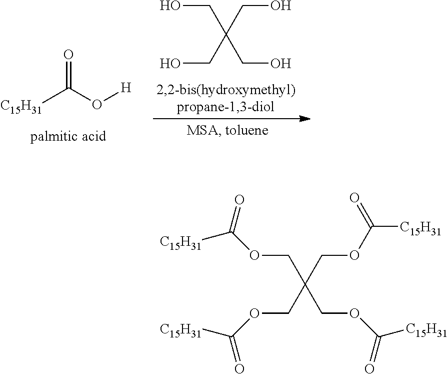

### 2,2-Bis((palmitoyloxy)methyl)propane-1,3-diyl dipalmitate

To a dry round bottom flask, palmitic acid (50 grams, 0.195 mol, 4 equiv.), 2,2-bis(hydroxymethyl)propane-1,3-diol (6.64 grams, 0.0475 mol, 1 equiv.), methane sulfonic acid (0.187 gram, 1%) and toluene (300 mL) were added. The round bottom flask was equipped with a Dean-Stark apparatus to remove the generated water during the reaction. The reaction flask was heated to 120° C. for 2 hours. After cooling to room temperature, the solution was extracted with sodium carbonate and the organic layer was dried by rotary evaporation. The obtained product was obtained as the neat desired product. (51 grams, 99% yield).

### Example 2

The palmitic acid ester obtained from Example 1 was blended with base oil at varying concentrations. Base oil (10 grams) and palmitic acid ester (1 gram, varying weight percents) were added to a beaker. The mixture was heated to 100° C. with stirring. After the whole mixture became homogeneous and transparent, the mixture was cooled to room temperature. The mixture was then used directly for physical property measurement.

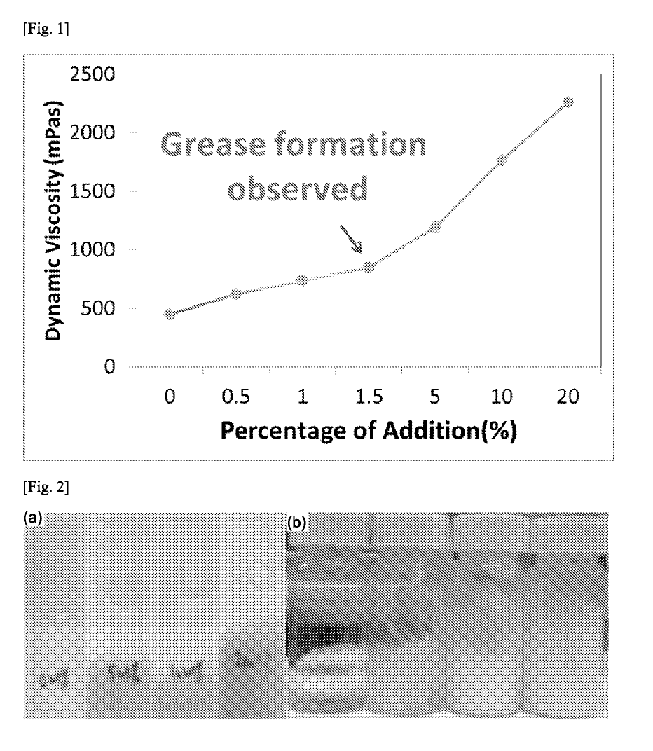

After addition of the palmitic acid based esters to commercial lubricant base oils, grease formation phenomenon and significant viscosity increase were observed, as can be seen in FIG. 1. As the prepared esters were simply blended with commercial engine oils with a low feed ratio (up to 1.5 wt. %), the viscosity of the generated mixture increased significantly and the final mixtures appeared greasy-like instead of oily (as observed in FIG. 2). This is a very interesting phenomenon and can be used for developing grease based formulation of lubricant. Other than commercial engine oil, a number of commercially available base oils, such as PEG, PPG, mineral oil, and synthetic esters have been tried and the ester additive can behave as a thickener and greater in a similar way. The additive behaves in a similar manner for most of the oils except for difference in the viscosity of the generated blends. For this example, PPG oil was used here.

### Thermal Properties of Blend

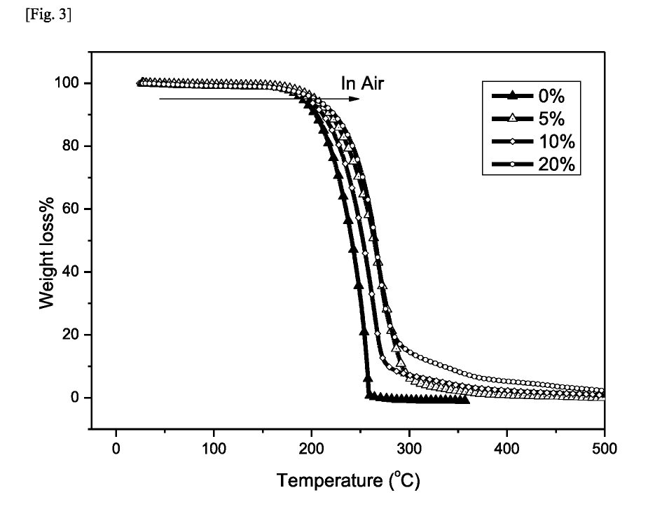

The thermal properties of the blend were analysed using a thermal gravimetric analysis (TGA) analyzer and differential scanning calorimetric (DSC) analyzer. The typical operation procedure of the TGA analyzer and DSC analyzer applies for the measurement of this sample. After addition of different ratios of thickeners into the polypropylene glycol (PPG) base oil at 5 wt %, 10 wt % and 20 wt %, there was no significant variation of the degradation temperature, which was steady around 210° C. (see FIG. 3). Polypropylene base oil without any addition of the thickener was used as a control.

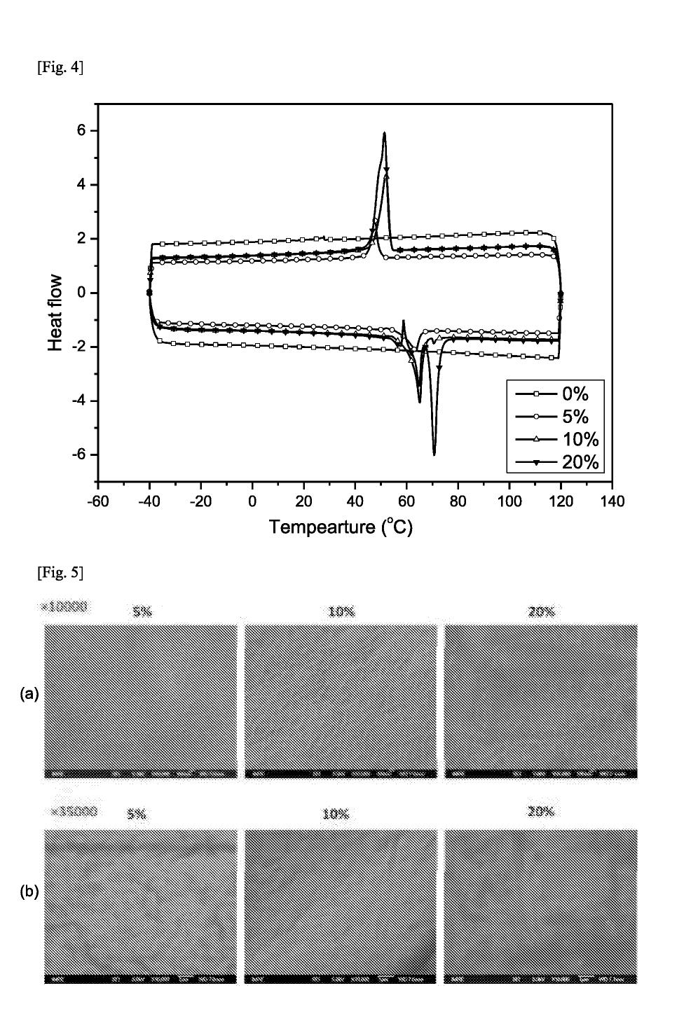

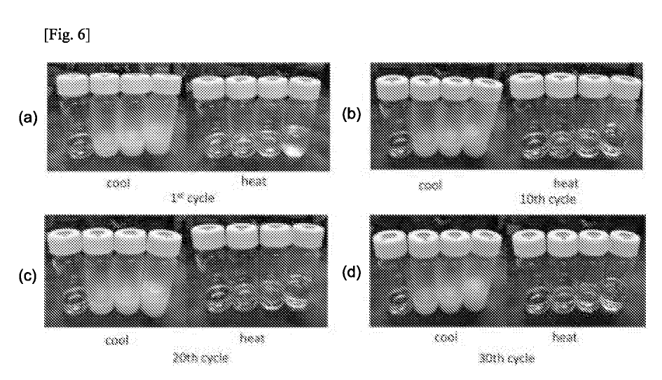

Differential scanning calorimetry data (see FIG. 4) showed that before addition of any thickeners, there was no phase transition of the PPG polymer up to 140° C. After addition of 5 wt % of the thickener, a clear transition at about 50° C. was clearly observed, which was mainly due to the melting of the additive. Upon further addition of the additive, the enthalpy of the melting peak became larger and larger. This indicates that the thickener is able to function up to 50° C. and can stabilize the grease at a temperature below this temperature.

### Morphology Analysis

The detailed morphology of the PPG/thickener blend was investigated by scanning electron microscopy to further understand why addition of the thickener will make the whole system creamy. At 5 wt % addition, it was found that very clear formation of interconnecting network type morphology was generated after the thickener was added into the PPG base oils. The diameter of each thread was about 500 nm. After introducing more thickeners, there was no significant variation of the network morphology. The observed interconnecting network-type morphology explained why the added thickener behaved as a gelling agent. As the network was formed, the PPG molecules were trapped within the network and the randomness of the oil was therefore reduced. As a result, the mixture became more viscious and creamy and after addition of more than 1.5 wt % of the thickener, the whole mixture became a gel (data not shown for 1.5 wt %).

### Thermo-Reversibility Analysis

The thermo-reversibility of the formed grease was also tested under heating-cooling cycles. As revealed by DSC measurements, after heating the grease sample to 80° C., a transparent solution was obtained for all three samples with different ratios of thickener (at 5 wt %, 10 wt % and 20 wt %). This indicated the melting of the thickener compounds in the PPG solution. After cooling to room temperature, the grease state was formed again, indicating the thermo-reversibility of the formed grease. After 30 heating-cooling cycles, there was no obvious morphological change of the grease compared with the initial state. This results indicated that the formed grease had very good thermo-reversibility. For all samples, PPG solution with no thickener added was used as control.

A summary of the thermal properties of the palmitic acid ester and base oil composite measured in this example is shown in Table 1 below.

TABLE 1
Summary of the thermal properties of the
palmitic acid ester and base oil composite.

| | | DSC transition |
|---|---|---|
| Composite (weight % of | | temperature |
| additive) | T_{g} (@5% mass loss) (° C.) | (° C.) |
| 0% | 191 | — |
| 5% | 202 | 63.9, 47.6 |
| 10% | 196 | 65.2, 52.1 |
| 20% | 204 | 64.9, 71.1, 51.3 |

Hence, the palmitic acid ester can be used to modify the rheological properties and lead to grease formation when added to a base oil.

### INDUSTRIAL APPLICABILITY

The palmitic acid ester can be used as an additive in natural and synthetic base oils. The palmitic acid ester can be blended with a variety of natural and synthetic base oils to prepare grease lubricant. The natural base oils can include mineral oils (light, heavy, paraffinic, naphthenic, aromatic, etc) and the synthetic base oils can include polyalphaolefins, synthetic esters, polyalkylene glycols, phosphate esters, alkylated naphthalenes, silicon oils, silicate esters, ionic fluids, etc. The grease lubricant can be used as potential water resistant grease formulation, food grade lubricant grease, railroad grease, sewing machine grease, gear lubrication, bearing lubrication and glassware joint lubrication.

The palmitic acid ester compounds can serve as an efficient grease formation agent to easily convert oil-type lubricant into grease and gel type lubricant. As the palmitic acid based esters are non-ionic, the use of the palmitic acid ester compound would widen the potential use of such lubricant in watery environment, such as underwater grease and marine grease.

The palmitic acid ester can be used as a viscosity modifier. Hence, the palmitic acid ester may be used for modifying the viscosity of a base oil as well as for forming grease.

As palmitic acid can be obtained from palm oil, the use of palmitic acid ester as a base oil additive is much cheaper and environmentally friendlier as compared to other base oil additives.

It will be apparent that various other modifications and adaptations of the invention will be apparent to the person skilled in the art after reading the foregoing disclosure without departing from the spirit and scope of the invention and it is intended that all such modifications and adaptations come within the scope of the appended claims.

1. A lubricating oil composition comprising:
a. a base oil; and
b. a base oil additive comprising an ester of a palmitic acid of the formula
R₂—(OOCC₁₅H₃₁)ₘ,
wherein R₂ is an alkyl, an alkenyl or an alkynyl; and
m is 2, 3, 4, 5 or 6, and
wherein said base oil additive is at a concentration of 1 wt % to 50.0 wt % based on the weight of the base oil.

2. The lubricating oil composition of claim 1, wherein said ester is a reaction product of said palmitic acid and an alcohol.

3. The lubricating oil composition of claim 2, wherein said alcohol is of the formula R₂—(OH)m, wherein R₂ is an alkyl, an alkenyl or an alkynyl; and m is 2, 3, 4, 5 or 6.

4. The lubricating oil composition of claim 3, wherein m is 2 and said alcohol is selected from the group consisting of ethylene glycol, propane-1,2-diol, propane-1,3-diol, butanediol, cyclohexanediol, cyclohexanedimethanol, dianhydrohexitol, diethylene glycol, dihydroxyacetone, dipropylene glycol, ethambutol, ethylhexylglycerin, etohexadiol, 1,6-hexanediol, neopentyl glycol, octane-1,8-diol, 1,5-pentanediol, pinacol, propylene glycol, tartaric acid and triethylene glycol.

5. The lubricating oil composition of claim 3, wherein m is 3, 4, 5 or 6 and said alcohol is selected from the group consisting of trimethylolpropane, trimethylolethane, 1,2,4-butanetriol, glycerol, miglitol, natural oil polyols, pentaerythritol, triethanolamine, maltitol, sorbital, xylitol, erythritol, isomalt, volemitol, threitol, arabitol, ribitol, mannitol, galactitol, iditol, fucitol, inositol, lactitol, isomalt, phloroglucinol, dipentaerythritol, 1,1,1-tris(hydroxymethyl)ethane, 2-hydromethyl-1,3-propanediol, 2,2-bis(hydroxymethyl)propane-1,3-diol, fragmented cellulose, fragmented chitosan, and fragmented lignin.

6. The lubricating oil composition of claim 5, wherein said alcohol is 2,2-bis(hydroxymethyl)propane-1,3-diol and said palmitic acid ester is 2,2-Bis((palmitoyloxy)methyl)propane-1,3-diyl dipalmitate, having

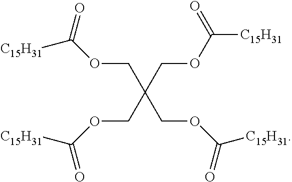

7. A method of forming a base oil additive comprising an ester of a palmitic acid of the formula
R₂—(OOCC₁₅H₃₁)ₘ,
wherein R₂ is an alkyl, an alkenyl or an alkynyl; and
m is 2, 3, 4, 5 or 6, and
wherein said base oil additive is at a concentration of 1 wt % to 50.0 wt % based on the weight of a base oil, comprising esterifying the palmitic acid in the presence of an acid catalyst selected from methanesulfonic acid and an alcohol to form an ester of said palmitic acid.

8. The method of claim 7, comprising the step of selecting the concentration of said acid catalyst from the range of 0.1 wt % to 10.0 wt %.

9. A method of modifying a property of lubricating oil composition comprising
a base oil, said method comprising adding an ester of a palmitic acid as an additive to said base oil, wherein said ester of palmitic acid is of the formula
R₂—(OOCC₁₅H₃₁)ₘ,
wherein R₂ is an alkyl, an alkenyl or an alkynyl; and
m is 2, 3, 4, 5 or 6, and
wherein said base oil additive is at a concentration of 1 wt % to 50.0 wt % based on the weight of the base oil.
